(19) United States
(12) Patent Application Publication
(10) Pub. No.: US 2015/0312258 A1
(43) Pub. Date: Oct. 29, 2015

(54) ACCESS RIGHT SETTING METHOD AND ACCESS RIGHT SETTING SYSTEM FOR USE IN AREA NETWORK

(71) Applicant: Primax Electronics Ltd., Neihu (TW)

(72) Inventor: Jung-Chang YANG, Neihu (TW)

(21) Appl. No.: 14/445,836

(22) Filed: Jul. 29, 2014

(30) Foreign Application Priority Data
Apr. 25, 2014 (TW) 103115052

(51) Int. Cl. H04L 29/06; G06F 21/60

(52) U.S. Cl. CPC H04L 63/10; G06F 21/604

(57) ABSTRACT

An access right setting method for use in an area network is provided. During the process of establishing a network connection between an active control device and a server-side device, a media access control address information of the active control device is retrieved, and the identity of the active control device is recognized according to the media access control address information. Subsequently, the access right information corresponding to the active control device is set. According to an operating request from the active control device, the server-side device judges whether the operating request complies with the predetermined access right information. Consequently, the server-side device is operated in a corresponding access right operation mode according to the access right information.

### FIELD OF THE INVENTION

The present invention relates to an access right setting method, and more particularly to an access right setting method for use in an area network.

### BACKGROUND OF THE INVENTION

Generally, an area network system comprises a local area network (LAN) system, a metropolitan area network (MAN) system and a wide area network (WAN) system. With increasing development of science and technology, the area network system further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored into the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 may be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a smart phone (i.e. used as the digital media controller or the digital media player) to be connected to a computer host (i.e. used as the digital media server) in a study room. Moreover, through the smart phone, the user may browse the audio files in the computer host and select a desired audio file from the computer host. Then, the selected audio file is transmitted from the smart phone to a stereo device (i.e. used as the digital media renderer) in the living room. After the audio file is received by the stereo set, the audio file is played by the stereo device. Consequently, the purposes of conveniently and quickly sharing media contents can be achieved by the DLNA system.

Although the DLNA system has the advantage of sharing media files, a privacy leakage problem may occur. For example, the digital media server of the DLNA system may contain a first folder and a second folder. The first folder contains plural media files (e.g. photos) of the family, and the second folder contains plural media files of the friends. In case that a friend visits an owner of the DLNA system, the friend can browse all media files in the first folder and the second folder at will because the DLNA system does not have the function of setting the access right. If the owner of the DLNA system does not want the family's media files to be browsed by the friend, the privacy leakage problem is generated.

Therefore, there is a need of providing an access right setting method and an access right setting system for use in an area network in order to set different access rights of different active control devices.

### SUMMARY OF THE INVENTION

An object of the present invention provides an access right setting method for use in an area network in order to set different access rights of different active control devices.

Another object of the present invention provides an access right setting system for setting different access rights of different active control devices.

In accordance with an aspect of the present invention, there is provided an access right setting method for use in an area network. The access right setting method includes the following steps. Firstly, a server-side device of the area network receives a first device search request from a first active control device of the area network. The first device search request contains a first media access control address information of the first active control device. Then, the first media access control address information is retrieved and stored into the server-side device, and a first response message corresponding to the first device search request is transmitted to the first active control device. Consequently, a network connection between the server-side device and the first active control device is established. Then, a first access right information corresponding to the first active control device is set into the server-side device according to the first media access control address information and an operation of the third-party device. When a first operating request from the first active control device is received by the server-side device, the server-side device is operated in a first access right operation mode or a second access right operation mode according to the first access right information and the first media access control address information of the first operating request.

In accordance with another aspect of the present invention, there is provided an access right setting system. The access right setting system includes a network router, a first active control device, and a server-side device. The network router provides a network connection function. The first active control device is connected to the network router through network connection. The first active control device has a first media access control address information. The server-side device is connected to the network router through network connection and connected to the first active control device via the network router through network connection. The server-side device receives the first media access control address information. A first access right information corresponding to the first active control device is set into the server-side device according to the first media access control address information and an operation of the third-party device. When a first operating request from the first active control device is received by the server-side device, the server-side device is operated in a first access right operation mode or a second access right operation mode according to the first access right information and the first media access control address information of the first operating request.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

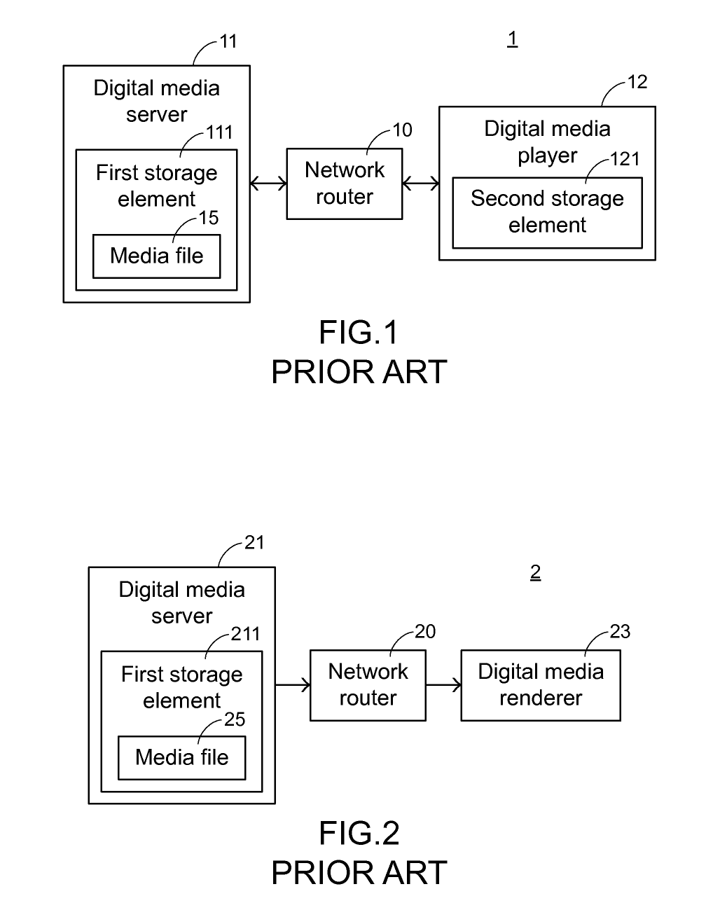

FIG. 2 schematically illustrates the architecture of a second conventional DLNA system;

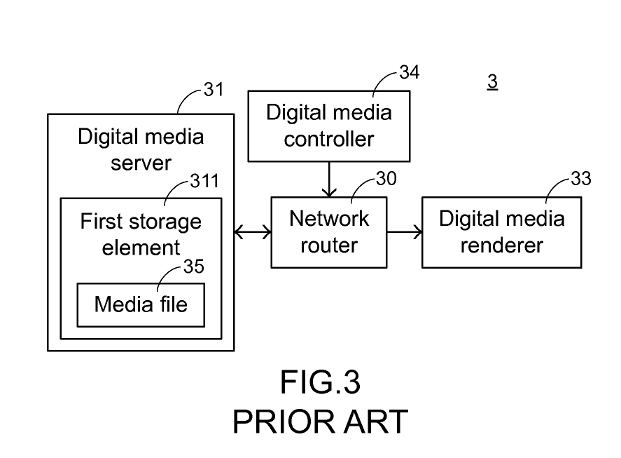

FIG. 3 schematically illustrates the architecture of a third conventional DLNA system;

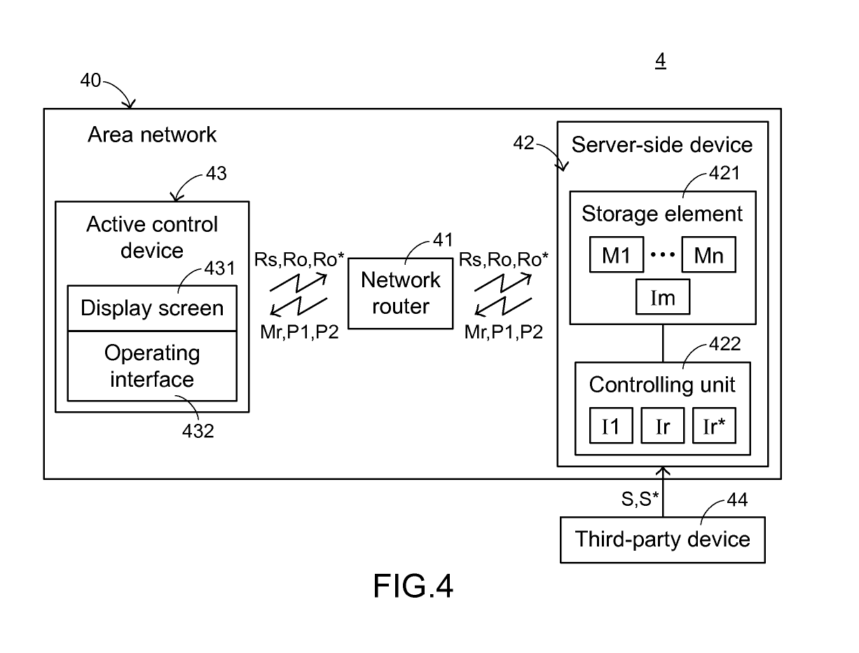

FIG. 4 is a schematic functional block diagram illustrating an access right setting system according to a first embodiment of the present invention;

FIG. 5 is a flowchart illustrating an access right setting method implemented by the access right setting system according to the first embodiment of the present invention;

FIG. 6 schematically illustrates the first access right setting interface of the access right setting system according to the first embodiment of the present invention;

FIG. 7 is a schematic functional block diagram illustrating an access right setting system according to a second embodiment of the present invention;

FIG. 8 schematically illustrates the second access right setting interface of the access right setting system according to the second embodiment of the present invention;

FIG. 9 is a schematic functional block diagram illustrating an access right setting system according to a third embodiment of the present invention;

FIG. 10 schematically illustrates the second access right setting interface of the access right setting system according to the third embodiment of the present invention;

FIG. 11 is a schematic functional block diagram illustrating an access right setting system according to a fourth embodiment of the present invention;

FIGS. 12A and 12B illustrates a flowchart of an access right setting method implemented by the access right setting system according to the fourth embodiment of the present invention; and

FIG. 13 schematically illustrates the first access right setting interface of the access right setting system according to the fourth embodiment of the present invention.

### DETAILED DESCRIPTION OF THE PREFERRED EMBODIMENT

For obviating the drawbacks of the prior art technologies, the present invention provides an access right setting method and an access right setting system for use in an area network.

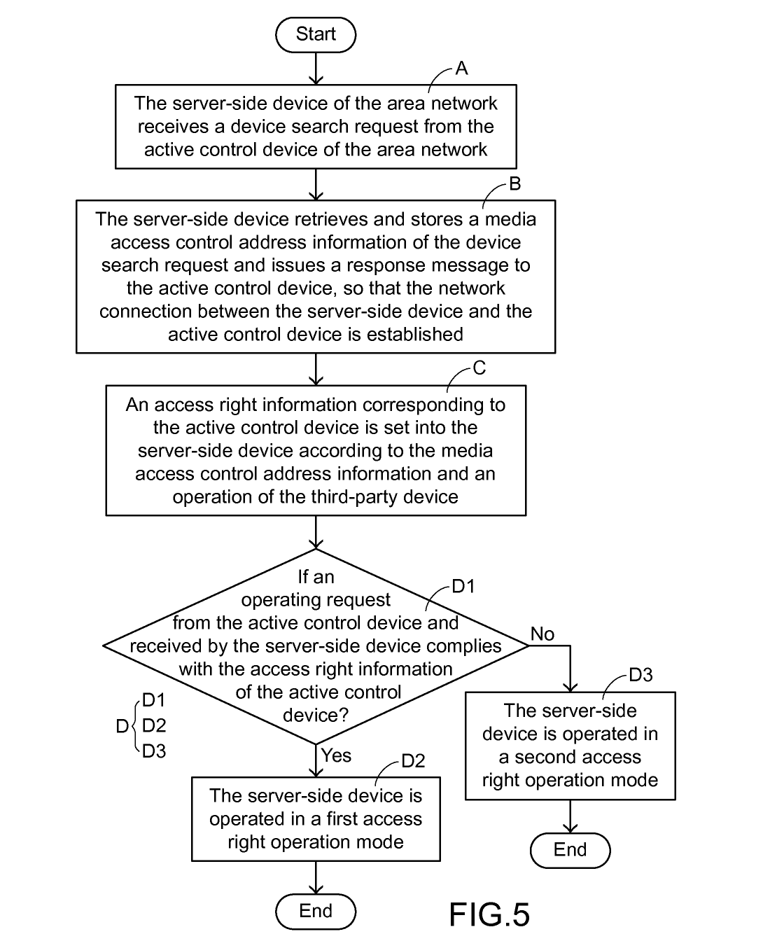

Hereinafter, an access right setting system of the present invention will be illustrated with reference to FIG. 4. FIG. 4 is a schematic functional block diagram illustrating an access right setting system according to a first embodiment of the present invention. As shown in FIG. 4, the access right setting system 4 comprises a network router 41, a server-side device 42, and an active control device 43. The server-side device 42 comprises a storage element 421 and a controlling unit 422. The network router 41 is used to provide a network connection function. The server-side device 42 and the active control device 43 are connected with each other via the network router 41 through network connection. The server-side device 42 is connected to the network router 41 through network connection. The server-side device 42 has three functions. Firstly, the server-side device 42 may store plural media files M1˜n therein. Secondly, an access right information Ir corresponding to the active control device 43 may be set into the server-side device 42. Thirdly, the server-side device 42 may be selectively operated in a first access right operation mode or a second access right operation mode, wherein the first access right operation mode is different from the second access right operation mode.

The storage element 421 is included in the server-side device 42 for storing the plural media files M1˜Mn. The controlling unit 422 is included in the server-side device 42 and connected to the storage element 421. The controlling unit 422 has the following functions. For example, the controlling unit 422 provides a first access right setting interface I1 for setting the access right information Ir corresponding to the active control device 43, or the controlling unit 422 is operated in the first access right operation mode according to the access right information Ir corresponding to the active control device 43, or the controlling unit 422 issues a failed message to the active control device 43. In this embodiment, the plural media files M1˜Mn are photo files. Moreover, the storage element 421 is a hard disc in the server-side device 42, and the controlling unit 422 is a microprocessor. Alternatively, in some other embodiments, the storage element is a flash drive or a portable hard disc drive that can be plugged into the digital media server. Alternatively, the storage element is a network storage space that is in communication with the server-side device through network connection.

The active control device 43 is connected to the network router 41 through network connection. Moreover, via the network router 41, the active control device 43 is connected with the server-side device 42 through network connection. The active control device 43 comprises a display screen 431 and an operating interface 432. The plural media files M1˜Mn stored in the storage element 421 may be displayed on the display screen 431. Via the operating interface 432, the user may operate the plural media files M1˜Mn in order to generate corresponding operation commands. In this embodiment, the network router 41, the server-side device 42 and the active control device 43 are collaboratively defined as an area network 40. In this embodiment, the server-side device 42 is a digital media server, and the active control device 43 is a digital media controller. The display screen 431 and the operating interface 432 are combined as a touch screen. Moreover, the network router 41 complies with the universal plug and play (UPnP) protocol. Moreover, both of the server-side device 42 and the active control device 43 comply with the Digital Living Network Alliance (DLNA) protocol.

The access right setting system 4 further comprises a third-party device 44. The third-party device 44 is not a member of the area network 40, but the third-party device 44 is connected to the server-side device 42 through network connection. The third-party device 44 may output an access right setting value S corresponding to the active control device 43. According to the access right setting value S, the access right information Ir corresponding to the active control device 43 is set. In this embodiment, the third-party device 44 is a computer system. The way of setting the access right information Ir will be illustrated later.

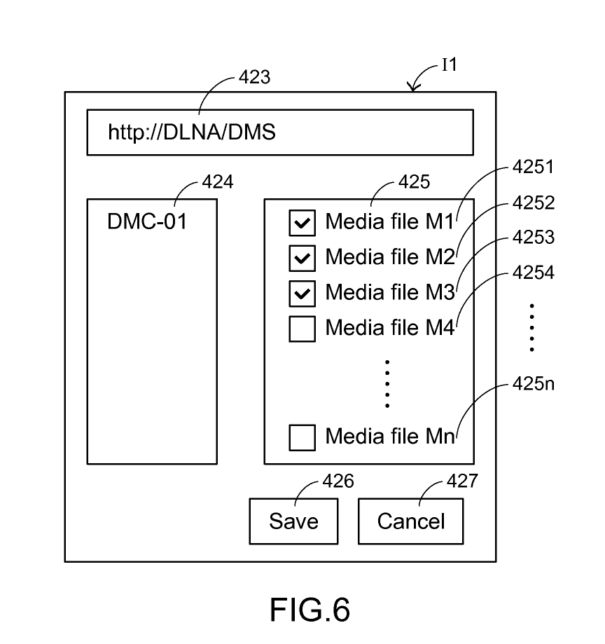

Hereinafter, an access right setting method for use in an area network according to the present invention will be illustrated with reference to FIG. 5. FIG. 5 is a flowchart illustrating an access right setting method implemented by the access right setting system according to the first embodiment of the present invention. The access right setting method comprises the following steps.

In a step A, a device search request from the active control device of the area network is received by the server-side device of the area network. In a step B, the server-side device retrieves and stores a media access control address information of the device search request and issues a response message to the active control device, so that the network connection between the server-side device and the active control device is established. In a step C, an access right information corresponding to the active control device is set into the server-side device according to the media access control address information and an operation of the third-party device. In a step D, when an operating request from the active control device is received, the server-side device is operated in a first access right operation mode or a second access right operation mode according to the access right information and the media access control address information of the operating request.

The step A and the step B are performed during the process of establishing the network connection of the DLNA system. The step C is used to set the access right information. The step D is performed in response to an operating request.

The step C comprises the following steps C1, C2 and C3. In the step C1, the third-party device is connected to the server-side device through network connection, and a first access right setting interface provided by the server-side device is opened. In the step C2, the server-side device receives an access right setting value corresponding to the active control device from the third-party device. In the step C3, the media access control address information and the access right setting value are stored into the server-side device as the access right information.

The step D comprises the following steps D1, D2 and D3. In the step D1, the server-side device receives an operating request from the active control device and judges whether the operating request complies with the access right information of the active control device. In the step D2, the server-side device is operated in the first access right operation mode. In the step D3, the server-side device is operated in the second access right operation mode.

Hereinafter, the detailed procedures of the access right setting method performed by the access right setting system 4 will be illustrated with reference to FIGS. 4 and 5. When the active control device 43 is enabled, a device search request Rs is automatically outputted from the active control device 43 according to the DLNA protocol. The device search request Rs contains a control device name information and a media access control address information Im corresponding to the active control device 43. That is, the step A is performed. The control device name information contains a control device name of the active control device 43. The media access control address information Im is the information of a media access control address (MAC Address) for defining a network location of the active control device 43 (e.g. 00:01:02:0A:0B:0C). After the device search request Rs is received by the server-side device 42, the server-side device 42 may recognize the identity and the network location of the active control device 43 according to the contents of the device search request Rs in order to facilitate establishing the network connection between the active control device 43 and the server-side device 42.

After the media access control address information Im is received by the server-side device 42, the controlling unit 422 retrieves the control device name information and the media access control address information Im corresponding to the active control device 43, and stores the media access control address information Im into the storage element 421. Meanwhile, a response message Mr corresponding to the device search request Rs is transmitted from the server-side device 42 to the active control device 43. The response message Mr contains a device name information and associated device information corresponding to the server-side device 42. Meanwhile, the network connection between the active control device 43 and the server-side device 42 is established. That is, the step B is performed.

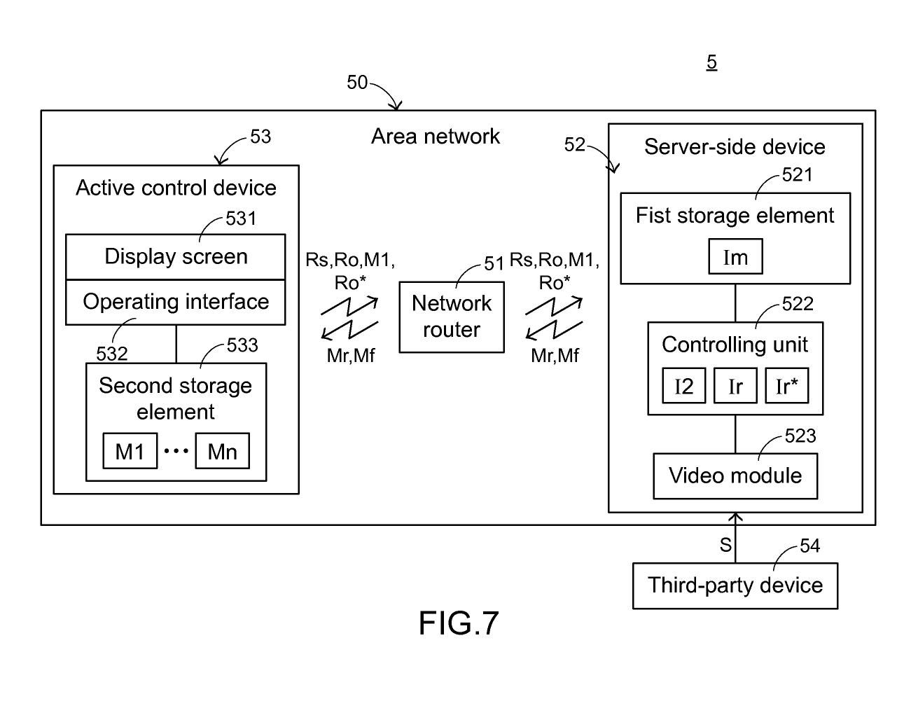

After the network connection between the active control device 43 and the server-side device 42 is established, a first user who supervises the server-side device 42 may perform the step C through the third-party device 44. In the step C1, the third-party device 44 is connected to the server-side device 42 through network connection (e.g. through the internet), and a first access right setting interface I1 provided by the controlling unit 422 of the server-side device 42 is opened. FIG. 6 schematically illustrates the first access right setting interface of the access right setting system according to the first embodiment of the present invention. As shown in FIG. 6, the first access right setting interface I1 comprises a website address bar 423, an active control device list 424, an operation setting field 425, a save button 426, and a cancel button 427. After the first user operates the third-party device 44 to input a website address corresponding to the server-side device 42 (e.g. http://DLNA/DMS), the third-party device 44 is connected to the first access right setting interface I1 through network connection, wherein the first access right setting interface I1 is provided by the server-side device 42. The website address http://DLNA/DMS is shown in the website address bar 423. Since the network connection between the active control device 43 and the server-side device 42 is established, the control device name corresponding to the active control device 43 (e.g. DMC-01) is shown in the active control device list 424. More especially, during the process of establishing the network connection between the server-side device 42 and plural active control devices, plural control device names corresponding to the plural active control devices are shown in the active control device list 424. Consequently, the control device names may be selected by the first user. Moreover, plural setting items 4251˜425n corresponding to the plural media files M1˜Mn are shown in the operation setting field 425. Consequently, the operation setting field 425 may be set by the first user through the third-party device 44.

In the step C2, the plural setting items 4251˜425n in the operation setting field 425 are selectively ticked by the first user through the third-party device 44. For example, the setting items 4251˜4253 are ticked. In addition, an access right setting value S corresponding to the active control device 43 is transmitted from the third-party device 44 to the server-side device 42. The access right setting value S contains the ticked setting data of the setting items 4251˜4253 and the unticked setting data of the setting items 4254˜425n. That is, according to the settings of the first user, the access right of browsing only the media files M1˜M3 is open to the active control device 43, but the access right of browsing the media files M4˜Mn is not open to the active control device 43. After the access right setting value S is received by the server-side device 42, the media access control address information Im and the access right setting value S corresponding to the active control device 43 are stored as the access right information Ir by the controlling unit 422. That is, the step C3 is performed.

Moreover, in the step C2, the first user may click the save button 426 of the first access right setting interface I1 in order to store the ticked setting data of the setting items 4251˜4253 and the unticked setting data of the setting items 4254˜425n. Whereas, the first user may click the cancel button 427 of the first access right setting interface I1 in order to cancel the setting procedure of the step C2.

After the step of setting the access right information is completed, the subsequent steps are performed. When a second user of the active control device 43 intends to browse the plural media files of the server-side device 42, the second user may select the server-side device 42 through the operating interface 432 of the active control device 43. Consequently, an operating request Ro corresponding to the action of browsing the server-side device 42 is transmitted from the active control device 43 to the server-side device 42. On the other hand, after the operating request Ro is received by the server-side device 42, the controlling unit 422 may realize that the active control device 43 is the device for browsing the server-side device 42 according to the access control address information Im in the operating request Ro. Meanwhile, the controlling unit 422 judges whether the operating request Ro complies with the access right information Ir of the active control device 43 according to the access right setting value S of the access right information Ir corresponding to the active control device 43. Since the access right setting value S contains the ticked setting data of the setting items 4251˜4253, the controlling unit 422 judges that the operating request Ro complies with the access right information Ir of the active control device 43. That is, the step D1 is performed. According to the judging result of the controlling unit 422, a first data packet P1 corresponding to the media files M1˜M3 is transmitted from the controlling unit 422 to the active control device 43. According to the first data packet P1, the media files M1˜M3 are displayed on the active control device 43 in order to be viewed by the second user. That is, the step D2 is performed. The procedures of opening a portion of the access right to the second user by the first user and the operations of the second user have been mentioned above.

Hereinafter, the procedures of not opening the access right to the second user by the first user and the operations of the second user will be illustrated as follows. In the step C, the plural setting items 4251˜425n in the operation setting field 425 are not ticked by the first user through the third-party device 44. In addition, an access right setting value S* corresponding to the active control device 43 is outputted from the third-party device 44. The access right setting value S* contains the unticked setting data of the setting items 4251˜425n. That is, the access right of browsing the media files M1˜Mn is not open to the active control device 43 by the first user. After the access right setting value S* is received by the server-side device 42, the media access control address information Im and the access right setting value S* corresponding to the active control device 43 are stored as the access right information Ir* by the controlling unit 422. That is, the step C is completed.

When the second user intends to browse the plural media files of the server-side device 42, the second user may select the server-side device 42 through the operating interface 432 of the active control device 43. Consequently, an operating request Ro* corresponding to the action of browsing the server-side device 42 is transmitted from the active control device 43 to the server-side device 42. On the other hand, after the operating request Ro* is received by the server-side device 42, the controlling unit 422 may realize that the active control device 43 is the device for browsing the server-side device 42 according to the access control address information Im in the operating request Ro*. Meanwhile, the controlling unit 422 judges whether the operating request Ro* complies with the access right information Ir* of the active control device 43 according to the access right setting value S* of the access right information Ir* corresponding to the active control device 43. Since the access right setting value S contains the unticked setting data of the setting items 4251˜425n, the controlling unit 422 judges that the operating request Ro* does not comply with the access right information Ir* of the active control device 43. That is, the step D1 is performed. According to the judging result of the controlling unit 422, a second data packet P2 corresponding to no media files is transmitted from the controlling unit 422 to the active control device 43. According to the second data packet P2, a blank displaying image is displayed on the active control device 43. That is, the step D3 is performed. Under this circumstance, the second user fails to browse any media file of the server-side device 42. Meanwhile, the access right setting method for use in the area network according to the present invention is completed.

The following two aspects should be specially described. Firstly, in this embodiment, the second data packet P2 corresponding to no media files is transmitted from the controlling unit 422 to the active control device 43 in the second access right operation mode. It is noted that the operations of the second access right operation mode are not restricted. For example, in another embodiment, a failed message is transmitted from the controlling unit to the active control device in the second access right operation mode. According to the failed message, the second user realizes that the media files in the server-side device cannot be browsed by the second user. Secondly, in this embodiment, the plural media files M1˜Mn are stored in the storage element 421, but are not limited thereto. Alternatively, in another embodiment, the media files M1˜M3 are stored in a default first folder of the storage element, and the media files M4˜Mn are stored in a default second folder of the storage element. In other words, the access right setting system of the present invention is not restricted to set the access right corresponding to media files. Nevertheless, the access right setting system of the present invention may be employed to set the access right corresponding to folders. Under this circumstance, since it is not necessary to successively set the access right corresponding to the media files, the procedures of the access right setting method are simplified.

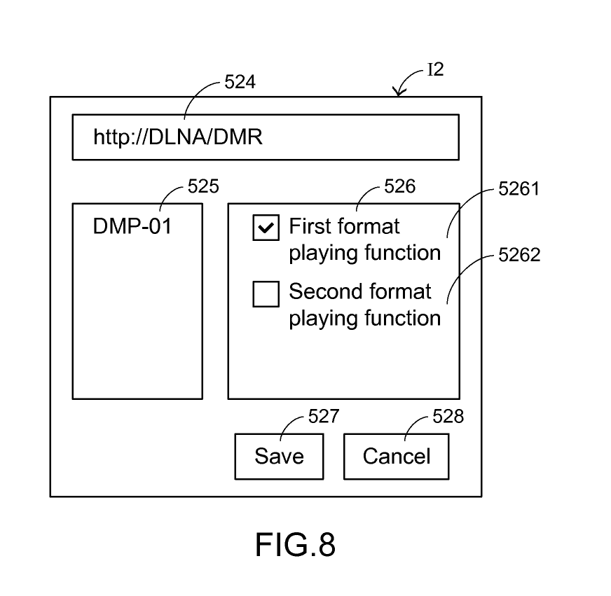

The present invention further provides a second embodiment, which is distinguished from the first embodiment. FIG. 7 is a schematic functional block diagram illustrating an access right setting system according to a second embodiment of the present invention. As shown in FIG. 7, the access right setting system 5 comprises a network router 51, a server-side device 52, and an active control device 53. The server-side device 52 comprises a first storage element 521, a controlling unit 522, and a video module 523. The active control device 53 comprises a display screen 531, an operating interface 532, and a second storage element 533. In this embodiment, the network router 51, the server-side device 52 and the active control device 53 are collaboratively defined as an area network 50. Except for the following two aspects, the architecture of the access right setting system 5 of this embodiment is identical to the architecture of the access right setting system 4 of the first embodiment, and is not redundantly described herein. Firstly, the video module 523 comprises a display screen and a stereo device. In addition, the controlling unit 522 has a function of playing first format media files and a function of playing second format media files. For example, the first format media files are MP3 format files, and the second format media files are MPG format files. In other words, the controlling unit 522 may control the video module 523 to play audio files with the MP3 format or play video files with the MPG format. In this embodiment, the server-side device 52 is a digital media renderer according to the DLNA protocol. For example, the server-side device 52 is a digital television.

Secondly, the structures and functions of the display screen 531 and the operating interface 532 of the active control device 53 are similar to those of the active control device 43 of the first embodiment, and are not redundantly described herein. The active control device 53 further comprises the second storage element 533. The plural media files M1˜Mn are stored in the second storage element 533. The media files M1˜M3 are audio files with the MP3 format. The media files M4˜Mn are video files with the MPG format. In this embodiment, the active control device 53 is a digital media controller according to the DLNA protocol.

Like the first embodiment, the access right setting system 5 further comprises the third-party device 54. The third-party device 54 is not a member of the area network 50, but the third-party device 54 is connected to the server-side device 52 through network connection. The third-party device 54 may output an access right setting value S corresponding to the active control device 53. According to the access right setting value S, the access right information Ir corresponding to the active control device 53 is set. In this embodiment, the third-party device 54 is a computer system. The steps of the access right setting method for use in the area network according to this embodiment are similar to those of the first embodiment. Consequently, the operations of the access right setting system 5 will be illustrated with reference to FIG. 5.

Hereinafter, the detailed procedures of the access right setting method performed by the access right setting system 5 will be illustrated with reference to FIGS. 5 and 7. In a step A, a device search request Rs is outputted from the active control device 53. The device search request Rs contains a control device name information and a media access control address information Im corresponding to the active control device 53. Then, the step B is performed. After the media access control address information Im is received by the server-side device 52, the controlling unit 522 retrieves the control device name information and the media access control address information Im corresponding to the active control device 53, and stores the media access control address information Im into the first storage element 521. Meanwhile, a response message Mr corresponding to the device search request Rs is transmitted from the server-side device 52 to the active control device 53. The response message Mr contains a device name information and associated device information corresponding to the server-side device 52. Consequently, the network connection between the active control device 53 and the server-side device 52 is established.

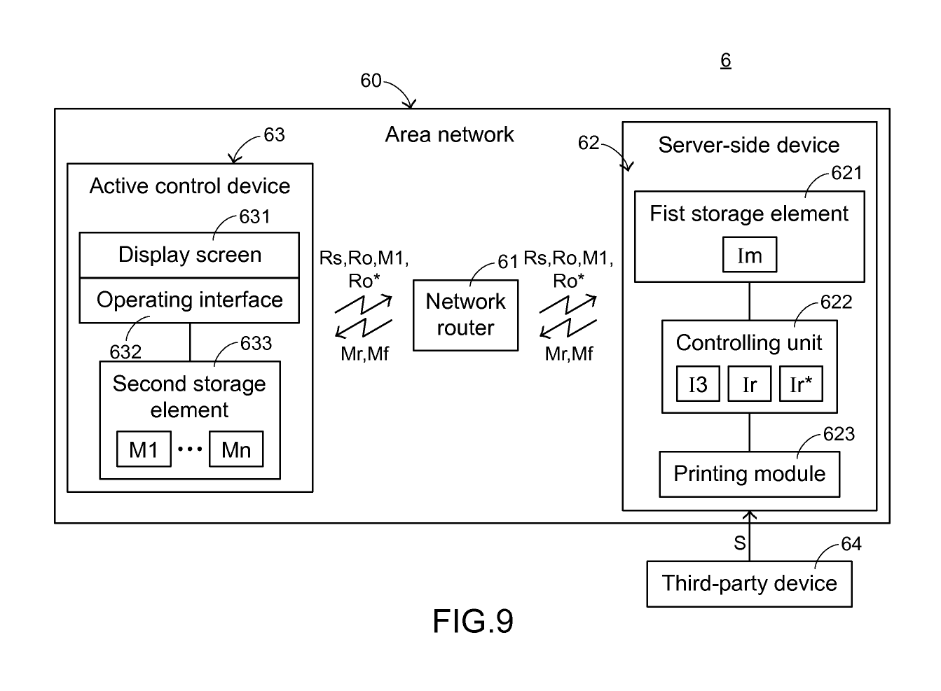

After the network connection between the active control device 53 and the server-side device 52 is established, a first user who supervises the server-side device 52 may perform the step C through the third-party device 54. In the step C1, the third-party device 54 is connected to the server-side device 52 through network connection (e.g. through the internet), and a second access right setting interface I2 provided by the server-side device 52 is opened. FIG. 8 schematically illustrates the second access right setting interface of the access right setting system according to the second embodiment of the present invention. As shown in FIG. 8, the second access right setting interface I2 comprises a website address bar 524, an active control device list 525, an operation setting field 526, a save button 527, and a cancel button 528. After the first user operates the third-party device 54 to input a website address corresponding to the server-side device 52 (e.g. http://DLNA/DMR), the third-party device 54 is connected to the second access right setting interface I2 through network connection, wherein the second access right setting interface I2 is provided by the server-side device 52. The website address http://DLNA/DMR is shown in the website address bar 524. Since the network connection between the active control device 53 and the server-side device 52 is established, the control device name corresponding to the active control device 53 (e.g. DMP-01) is shown in the active control device list 525. Moreover, a setting item 5261 corresponding to the first format playing function and a setting item 5262 corresponding to the second format playing function are shown in the operation setting field 526. Consequently, the operation setting field 526 may be set by the first user through the third-party device 54.

In the step C2, the setting item 5261 corresponding to the first format playing function is ticked by the first user through the third-party device 54. In addition, an access right setting value S corresponding to the active control device 53 is transmitted from the third-party device 54 to the server-side device 52. The access right setting value S contains the ticked setting data of the setting item 5261 corresponding to the first format playing function and the unticked setting data of the setting item 5262 corresponding to the second format playing function. That is, according to the settings of the first user, the access right of playing only the first format media files is open to the active control device 53, but the access right of playing the second format media files is not open to the active control device 53. After the access right setting value S is received by the server-side device 52, the media access control address information Im and the access right setting value S corresponding to the active control device 53 are stored as the access right information Ir by the controlling unit 522. That is, the step C3 is performed.

Moreover, in the step C2, the first user may click the save button 527 of the second access right setting interface I2 in order to store the ticked setting data of the setting item 5261 corresponding to the first format playing function and the unticked setting data of the setting item 5262 corresponding to the second format playing function. Whereas, the first user may click the cancel button 528 of the second access right setting interface I2 in order to cancel the setting procedure of the step C2.

When a second user of the active control device 53 intends to play the media file M1 of the active control device 53 through the server-side device 52, the second user may select the server-side device 52 through the operating interface 532 of the active control device 53. Consequently, an operating request Ro corresponding to the action of controlling the playback of the server-side device 52 is transmitted from the active control device 53 to the server-side device 52. On the other hand, after the operating request Ro is received by the server-side device 52, the controlling unit 522 may realize that the active control device 53 is the device that controls the server-side device 52 according to the access control address information Im in the operating request Ro. Meanwhile, the controlling unit 522 judges whether the operating request Ro complies with the access right information Ir according to the access right setting value S of the access right information Ir corresponding to the active control device 53. Since the access right setting value S contains the ticked setting data of the setting item 5261 corresponding to the first format playing function, the controlling unit 522 judges that the operating request Ro complies with the access right information Ir of the active control device 53. That is, the step D1 is performed. According to the judging result of the controlling unit 522, the controlling unit 522 issues a retrieve request to retrieve the media file M1 from the active control device 53. In response to the retrieve request, the media file M1 is transmitted from the active control device 53 to the server-side device 52. Moreover, the media file M1 is temporarily stored into the first storage element 521, and played by the video module 523. That is, the step D2 is performed. The procedures of opening a portion of the access right to the second user by the first user and the operations of the second user have been mentioned above.

Hereinafter, the procedures of not opening the access right to the second user by the first user and the operations of the second user will be illustrated as follows. When the second user of the active control device 53 intends to play the media file Mn of the active control device 53 through the server-side device 52, the second user may select the server-side device 52 through the operating interface 532 of the active control device 53. Consequently, an operating request Ro* corresponding to the action of controlling the playback of the server-side device 52 is transmitted from the active control device 53 to the server-side device 52. On the other hand, after the operating request Ro* is received by the server-side device 52, the controlling unit 522 may realize that the active control device 53 is the device that controls the server-side device 52 according to the access control address information Im in the operating request Ro*. Meanwhile, the controlling unit 522 judges whether the operating request Ro* complies with the access right information Ir according to the access right setting value S of the access right information Ir corresponding to the active control device 53. Since the access right setting value S only contains the ticked setting data of the setting item 5261 corresponding to the first format playing function, the controlling unit 522 judges that the operating request Ro* does not comply with the access right information Ir of the active control device 53. That is, the step D1 is performed. According to the judging result of the controlling unit 522, the controlling unit 522 issues a failed message Mf to the active control device 53. According to the failed message Mf, the second user realizes that the media file Mn cannot be played by the server-side device 52. That is, the step D3 is performed. Meanwhile, the access right setting method for use in the area network according to the present invention is completed.

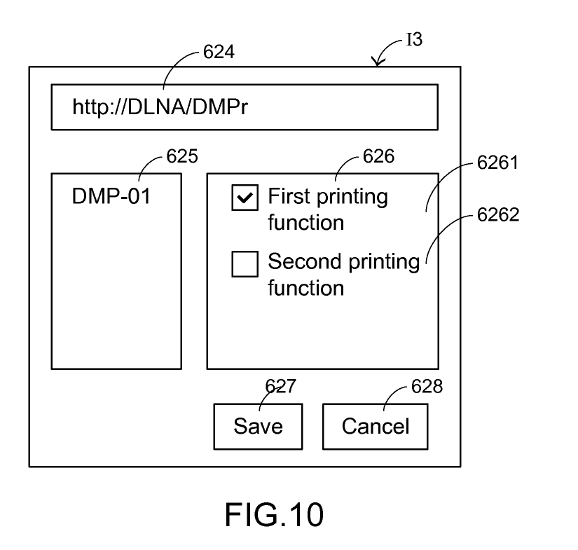

The present invention further provides a third embodiment, which is distinguished from the first embodiment. FIG. 9 is a schematic functional block diagram illustrating an access right setting system according to a third embodiment of the present invention. As shown in FIG. 9, the access right setting system 6 comprises a network router 61, a server-side device 62, and an active control device 63. The server-side device 62 comprises a first storage element 621, a controlling unit 622, and a printing module 623. The active control device 63 comprises a display screen 631, an operating interface 632, and a second storage element 633. In this embodiment, the network router 61, the server-side device 62 and the active control device 63 are collaboratively defined as an area network 60. Except for the following aspects, the architecture of the access right setting system 6 of this embodiment is identical to the architecture of the access right setting system 5 of the second embodiment, and is not redundantly described herein. In comparison with the access right setting system 5, the printing module 623 of the access right setting system 6 is used for printing the media files. In addition, the controlling unit 622 has a first printing function and a second printing function. For example, the first printing function is a black and white printing function, and the second printing function is a color printing function. Alternatively, the number of papers to be printed is unlimited according to the first printing function, and the number of papers to be printed is limited (e.g. ten papers) according to the second printing function. In other words, the controlling unit 622 may control the printing module 623 to implement the black and white printing function or the color printing function. In this embodiment, the server-side device 62 is a digital media printer according to the DLNA protocol.

The structures and functions of the display screen 631, the operating interface 632 and the second storage element 633 of the active control device 63 are similar to those of the active control device 53 of the second embodiment, and are not redundantly described herein.

The active control device 63 further comprises the second storage element 633. The plural media files M1˜Mn stored in the second storage element 633 are photo files rather than audio files. Like the second embodiment, the access right setting system 6 further comprises a third-party device 64. Through the third-party device 64, the access right information Ir corresponding to the active control device 63 can be set.

Hereinafter, the detailed procedures of the access right setting method performed by the access right setting system 6 will be illustrated with reference to FIGS. 5 and 9. In a step A, a device search request Rs is outputted from the active control device 63. The device search request Rs contains a control device name information and a media access control address information Im corresponding to the active control device 63. Then, the step B is performed. After the media access control address information Im is received by the server-side device 62, the controlling unit 622 retrieves the control device name information and the media access control address information Im corresponding to the active control device 63, and stores the media access control address information Im into the first storage element 621. Meanwhile, a response message Mr corresponding to the device search request Rs is transmitted from the server-side device 62 to the active control device 63. The response message Mr contains a device name information and associated device information corresponding to the server-side device 62. Consequently, the network connection between the active control device 63 and the server-side device 62 is established.

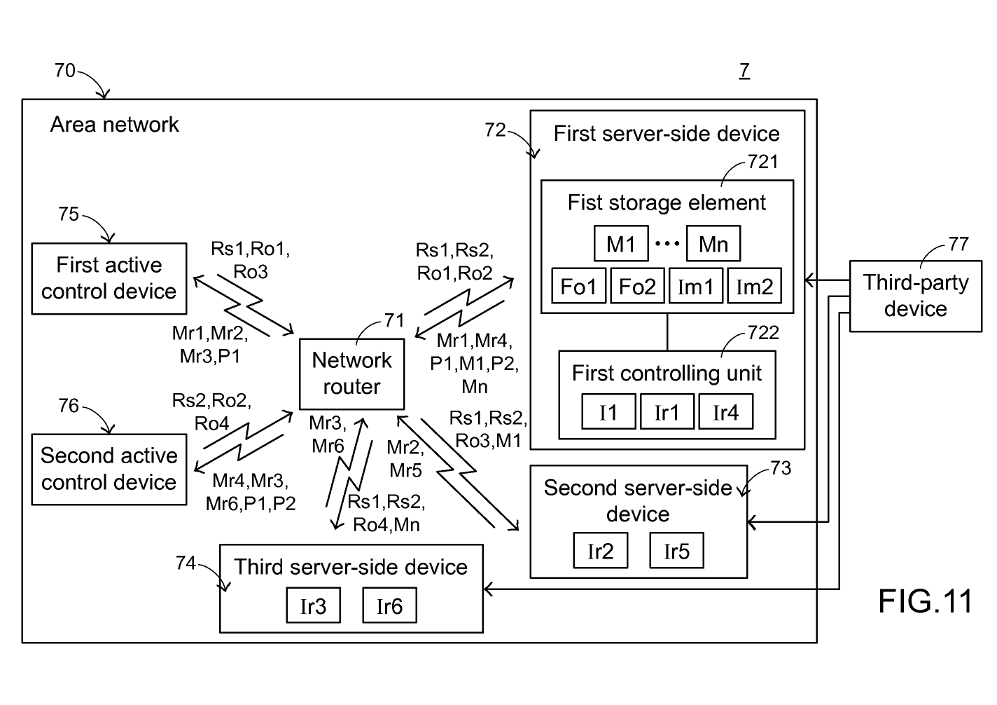

After the network connection between the active control device 63 and the server-side device 62 is established, a first user who supervises the server-side device 62 may perform the step C through the third-party device 64. In the step C1, the third-party device 64 is connected to the server-side device 62 through network connection (e.g. through the internet), and a third access right setting interface I3 provided by the server-side device 62 is opened. FIG. 10 schematically illustrates the second access right setting interface of the access right setting system according to the third embodiment of the present invention. As shown in FIG. 10, the third access right setting interface I3 comprises a website address bar 624, an active control device list 625, an operation setting field 626, a save button 627, and a cancel button 628. After the first user operates the third-party device 64 to input a website address corresponding to the server-side device 62 (e.g. http://DLNA/DMPr), the third-party device 64 is connected to the third access right setting interface I3 through network connection, wherein the third access right setting interface I3 is provided by the server-side device 62. The website address http://DLNA/DMPr is shown in the website address bar 624. Since the network connection between the active control device 63 and the server-side device 62 is established, the control device name corresponding to the active control device 63 (e.g. DMP-01) is shown in the active control device list 625. Moreover, a setting item 6261 corresponding to the first printing function and a setting item 6262 corresponding to the second printing function are shown in the operation setting field 626. Consequently, the operation setting field 626 may be set by the first user through the third-party device 64.

In the step C2, the setting item 6261 corresponding to the first printing function is ticked by the first user through the third-party device 64. In addition, an access right setting value S corresponding to the active control device 63 is transmitted from the third-party device 64 to the server-side device 62. The access right setting value S contains the ticked setting data of the setting item 6261 corresponding to the first printing function and the unticked setting data of the setting item 6262 corresponding to the second printing function. That is, according to the settings of the first user, the access right of the first printing function is open to the active control device 63, but the access right of the second printing function is not open to the active control device 63. After the access right setting value S is received by the server-side device 62, the media access control address information Im and the access right setting value S corresponding to the active control device 63 are stored as the access right information Ir by the controlling unit 622. That is, the step C3 is performed.

Moreover, in the step C2, the first user may click the save button 627 of the third access right setting interface I3 in order to store the ticked setting data of the setting item 6261 corresponding to the first printing function and the unticked setting data of the setting item 6262 corresponding to the second printing function. Whereas, the first user may click the cancel button 628 in order to cancel the setting procedure of the step C2.

When a second user of the active control device 63 intends to perform a black and white printing operation on the media file M1 of the active control device 63 through the server-side device 62, the second user may select the server-side device 62 through the operating interface 632 of the active control device 63. Consequently, an operating request Ro corresponding to the action of controlling the printing operation of the server-side device 62 is transmitted from the active control device 63 to the server-side device 62. On the other hand, after the operating request Ro is received by the server-side device 62, the controlling unit 622 may realize that the active control device 63 is the device that controls the server-side device 62 according to the access control address information Im in the operating request Ro. Meanwhile, the controlling unit 622 judges whether the operating request Ro complies with the access right information Ir according to the access right setting value S of the access right information Ir corresponding to the active control device 63. Since the access right setting value S contains the ticked setting data of the setting item 6261 corresponding to the first printing function (i.e. the black and white printing function), the controlling unit 622 judges that the operating request Ro complies with the access right information Ir of the active control device 63. That is, the step D1 is performed. According to the judging result of the controlling unit 622, the controlling unit 622 issues a retrieve request to retrieve the media file M1 from the active control device 63. In response to the retrieve request, the media file M1 is transmitted from the active control device 63 to the server-side device 62. Moreover, the media file M1 is temporarily stored into the first storage element 621, and the black and white printing operation is performed on the media file M1 by the printing module 623. That is, the step D2 is performed. The procedures of opening a portion of the access right to the second user by the first user and the operations of the second user have been mentioned above.

When the second user of the active control device 63 intends to perform a color printing operation on the media file M1 of the active control device 63 through the server-side device 62, the second user may select the server-side device 62 through the operating interface 632 of the active control device 63. Consequently, an operating request Ro* corresponding to the action of controlling the printing operation of the server-side device 62 is transmitted from the active control device 63 to the server-side device 62. On the other hand, after the operating request Ro* is received by the server-side device 62, the controlling unit 622 may realize that the active control device 63 is the device that controls the server-side device 62 according to the access control address information Im in the operating request Ro*. Meanwhile, the controlling unit 622 judges whether the operating request Ro* complies with the access right information Ir according to the access right setting value S of the access right information Ir corresponding to the active control device 63. Since the access right setting value S only contains the ticked setting data of the setting item 6261 corresponding to the first printing function (i.e. the black and white printing function), the controlling unit 622 judges that the operating request Ro* does not comply with the access right information Ir of the active control device 63. That is, the step D1 is performed. According to the judging result of the controlling unit 622, the controlling unit 622 issues a failed message Mf to the active control device 63. According to the failed message Mf, the second user realizes that the color printing operation cannot be performed on the media file M1 by the server-side device 62. That is, the step D3 is performed. Meanwhile, the access right setting method for use in the area network according to the present invention is completed.

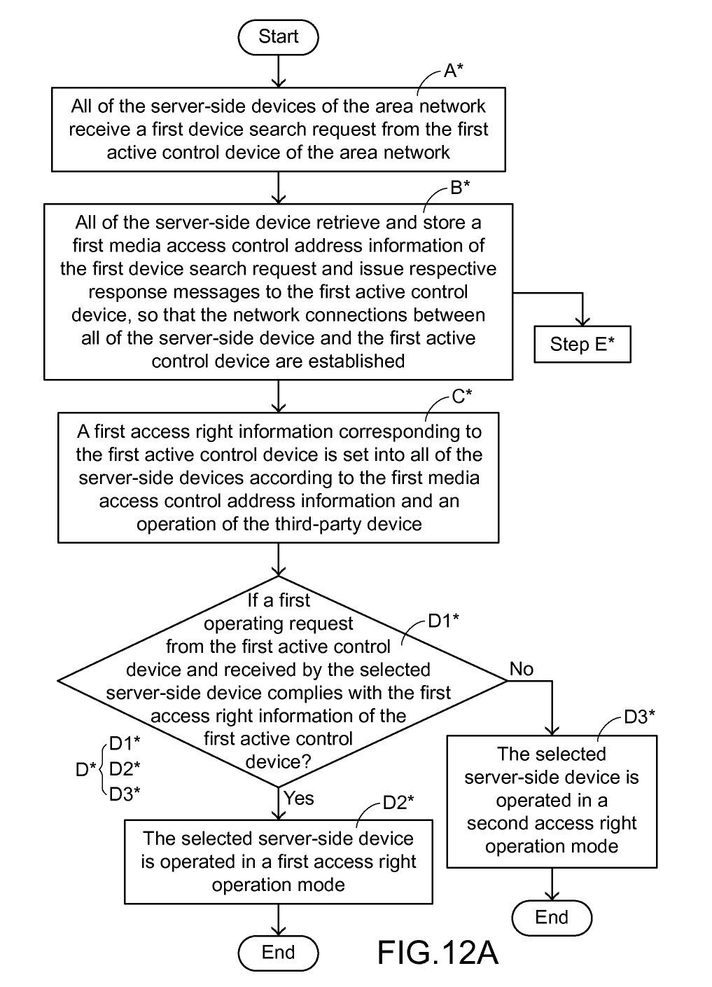

The present invention further provides a fourth embodiment, which is distinguished from the first embodiment. FIG. 11 is a schematic functional block diagram illustrating an access right setting system according to a fourth embodiment of the present invention. As shown in FIG. 11, the access right setting system 7 comprises a network router 71, a first server-side device 72, a second server-side device 73, a third server-side device 74, a first active control device 75, and a second active control device 76. In this embodiment, the network router 71, the first server-side device 72, the second server-side device 73, the third server-side device 74, the first active control device 75 and the second active control device 76 are collaboratively defined as an area network 70. In this embodiment, the first server-side device 72 is a digital media server, the second server-side device 73 is a digital media renderer, the third server-side device 74 is a digital media printer, the first active control device 75 is a digital media controller, and the second active control device 76 is a digital media player.

In the area network 70, the first server-side device 72 is substantially identical to the server-side device 42 of the first embodiment. Moreover, the first server-side device 72 comprises a first storage element 721 and a first controlling unit 722. The structures and functions of the first storage element 721 and the first controlling unit 722 are similar to those of the server-side device 42 of the first embodiment, and are not redundantly described herein. Moreover, plural media files M1˜Mn are stored in the first storage element 721. The media files M1˜M3 are contained in a default first folder Fo1, which is previously stored in the first storage element 721. The media files M4˜Mn are contained in a default second folder Fo2, which is previously stored in the first storage element 721. In this embodiment, the media files M1˜M3 are audio files with the MPEG format, and the media files M4˜Mn are photo files with the JPEG format. The second server-side device 73 is substantially identical to the server-side device 52 of the second embodiment. The second server-side device 73 comprises a second storage element, a second controlling unit, and a video module. The structures and functions of the second storage element, the second controlling unit and the video module are similar to those of the server-side device 52 of the second embodiment, and are not redundantly described herein. For clarification and succinctness, the second storage element, the second controlling unit and the video module are not shown in FIG. 11. The third server-side device 74 is substantially identical to the server-side device 62 of the third embodiment. The third server-side device 74 comprises a third storage element, a third controlling unit, and a printing module. The structures and functions of the third storage element, the third controlling unit and the printing module are similar to those of the server-side device 62 of the third embodiment, and are not redundantly described herein. For clarification and succinctness, the third storage element, the third controlling unit and the printing module are not shown in FIG. 11.

The first active control device 75 is substantially identical to the active control device 43 of the first embodiment. The first active control device 75 comprises a first display screen and a first operating interface. The structures and functions of the first display screen and the first operating interface are similar to those of the active control device 43 of the first embodiment, and are not redundantly described herein. For clarification and succinctness, the first display screen and the first operating interface are not shown in FIG. 11. The second active control device 76 is substantially identical to the active control device 53 of the second embodiment. The second active control device 76 comprises a second display screen, a second operating interface, and a fourth storage element. The structures and functions of the second display screen and the second operating interface are similar to those of the active control device 53 of the second embodiment, and are not redundantly described herein. For clarification and succinctness, the second display screen, the second operating interface and the fourth storage element are not shown in FIG. 11. Moreover, no media files are stored in the fourth storage element. Alternatively, the fourth storage element may store media files.

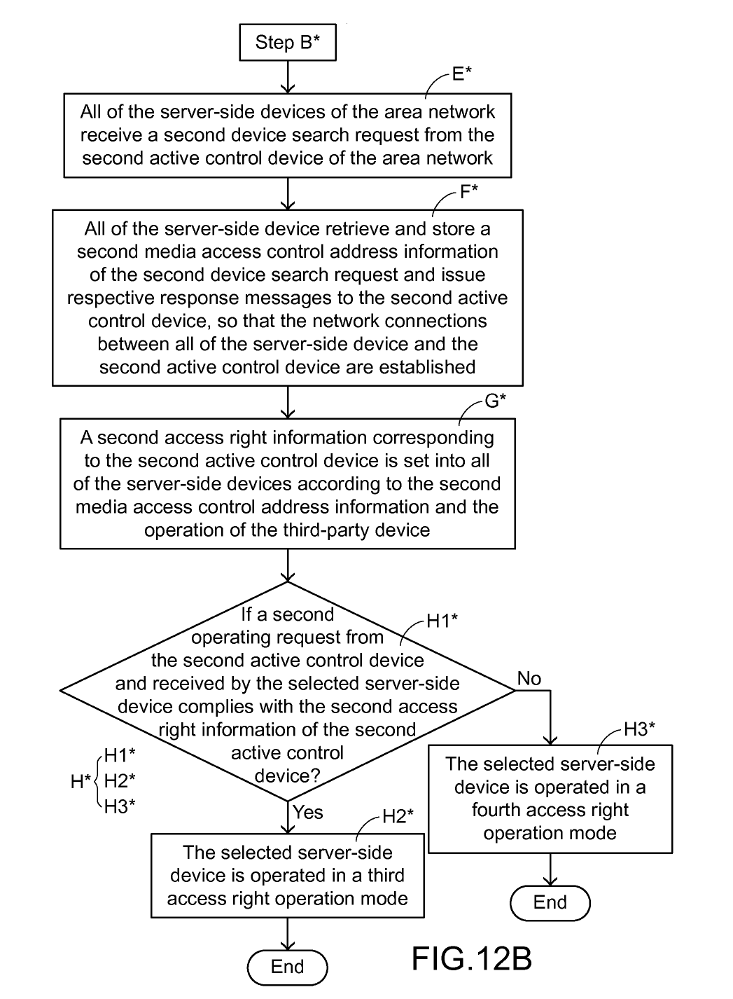

Hereinafter, an access right setting method for use in an area network according to the present invention will be illustrated with reference to FIGS. 12A and 12B. FIGS. 12A and 12B illustrates a flowchart of an access right setting method implemented by the access right setting system according to the fourth embodiment of the present invention. The access right setting method comprises the following steps.

In a step A*, a first device search request from the first active control device of the area network is received by all of the server-side devices of the area network. In a step B *, all of the server-side devices retrieve and store a first media access control address information of the first device search request and issue respective response messages to the first active control device, so that the network connections between all of the server-side devices and the first active control device are established. In a step C*, a first access right information corresponding to the first active control device is set into all of the server-side devices according to the first media first access control address information and an operation of the third-party device. In an step D*, when a first operating request from the first active control device is received by a selected server-side device, the selected server-side device is operated in a first access right operation mode or a second access right operation mode according to the first access right information and the first media access control address information of the first operating request. In a step E*, a second device search request from the second active control device of the area network is received by all of the server-side devices of the area network. In a step F*, all of the server-side devices retrieve and store a second media access control address information of the second device search request and issue respective response messages to the second active control device, so that the network connections between all of the server-side devices and the second active control device are established. In a step G*, all of the server-side devices set a second access right information corresponding to the second active control device according to the second media first access control address information and the operation of the third-party device. In an step H*, when a second operating request from the second active control device is received by the selected server-side device, the selected server-side device is operated in a third access right operation mode or a fourth access right operation mode according to the second access right information and the second media access control address information of the second operating request. The steps E*˜G* are performed after the step B*.

The step C* comprises the following steps C1*, C2* and C3*. In the step C1*, the third-party device is connected to the selected server-side device through network connection, and a first access right setting interface provided by the selected server-side device is opened. In the step C2*, the selected server-side device receives a first access right setting value corresponding to the first active control device from the third-party device. In the step C3*, the first media access control address information and the first access right setting value are stored into the selected server-side device as the first access right information.

The step D* comprises the following steps D1*, D2* and D3*. In the step D1*, the selected server-side device receives a first operating request from the first active control device and judges whether the first operating request complies with the first access right information of the first active control device. In the step D2*, the selected server-side device is operated in the first access right operation mode. In the step D3*, the selected server-side device is operated in the second access right operation mode.

The step G* is similar to the step C*. The step G* comprises the following steps G1*, G2* and G3*. In the step G1*, the third-party device is connected to the selected server-side device through network connection, and a second access right setting interface provided by the selected server-side device is opened. In the step G2*, the selected server-side device receives a second access right setting value corresponding to the second active control device from the third-party device. In the step G3*, the second media access control address information and the second access right setting value are stored into the selected server-side device as the second access right information.

The step H* is similar to the step D*. The step H* comprises the following steps H1*, H2* and H3*. In the step H1 *, the selected server-side device receives a second operating request from the second active control device and judges whether the second operating request complies with the second access right information of the second active control device. In the step H2*, the selected server-side device is operated in the third access right operation mode. In the step H3*, the selected server-side device is operated in the fourth access right operation mode.

Hereinafter, the detailed procedures of the access right setting method performed by the access right setting system 7 will be illustrated with reference to FIGS. 11, 12A and 12B.

In the step A*, a first device search request Rs 1 is outputted from the first active control device 75. The first device search request Rs1 contains a first control device name information and a first media access control address information Im1 corresponding to the first active control device 75.

In the step B*, the first media access control address information Im1 is received by the first server-side device 72, the second server-side device 73 and the third server-side device 74. In the first server-side device 72, the first controlling unit 722 retrieves the first control device name information and the first media access control address information Im1 corresponding to the first active control device 75, and stores the first media access control address information Im1 into the first storage element 721. Meanwhile, a first response message Mr1 corresponding to the first device search request Rs1 is transmitted from the first server-side device 72 to the first active control device 75. The first response message Mrl contains a first device name information and associated device information corresponding to the first server-side device 72. Consequently, the network connection between the first active control device 75 and the first server-side device 72 is established.

Like the first server-side device 72, a second response message Mr2 corresponding to the first device search request Rs1 is transmitted from the second server-side device 73 to the first active control device 75. The second response message Mr2 contains a second device name information and associated device information corresponding to the second server-side device 73. Consequently, the network connection between the first active control device 75 and the second server-side device 73 is established. Like the first server-side device 72, a third response message Mr3 corresponding to the first device search request Rs1 is transmitted from the third server-side device 74 to the first active control device 75. The third response message Mr3 contains a third device name information and associated device information corresponding to the third server-side device 74. Consequently, the network connection between the first active control device 75 and the third server-side device 74 is established.

Then, the step C* is performed. That is, a first user who supervises the first server-side device 72 may set the first access right information In corresponding to the first active control device 75 through the third-party device 77. The procedures of setting the first access right information In are similar to the procedures of the step C of the first embodiment, and are not redundantly described herein. That is, according to the settings of the first user, the access right of browsing the first folder Fo1 is open to the first active control device 75, but the access right of browsing the second folder Fo2 is not open to the first active control device 75. Similarly, the first user who supervises the second server-side device 73 may set the second access right information Ir2 corresponding to the first active control device 75 through the third-party device 77. The procedures of setting the second access right information Ir2 are similar to the procedures of the step C of the second embodiment, and are not redundantly described herein. That is, according to the settings of the first user, the access right of browsing the first format media files is open to the first active control device 75, but the access right of browsing the second format media files is not open to the first active control device 75. Similarly, the first user who supervises the third server-side device 74 may set the third access right information Ir3 corresponding to the first active control device 75 through the third-party device 77. The procedures of setting the third access right information Ir3 are similar to the procedures of the step C of the third embodiment, and are not redundantly described herein. That is, according to the settings of the first user, the access right of the first printing function is open to the first active control device 75, but the access right of the second printing function is not open to the first active control device 75. Meanwhile, the step C* is completed.

Then, the step E* is performed. In the step E*, a second device search request Rs2 is outputted from the second active control device 76. The second device search request Rs2 contains a second control device name information and a second media access control address information Im2 corresponding to the second active control device 76.

In the step F*, the second media access control address information Im2 is received by the first server-side device 72, the second server-side device 73 and the third server-side device 74. In the first server-side device 72, the first controlling unit 722 retrieves the second control device name information and the second media access control address information Im2 corresponding to the second active control device 76, and stores the second media access control address information Im2 into the first storage element 721. Meanwhile, a fourth response message Mr4 corresponding to the second device search request Rs2 is transmitted from the first server-side device 72 to the second active control device 76. The fourth response message Mr4 contains the first device name information and associated device information corresponding to the first server-side device 72. Consequently, the network connection between the second active control device 76 and the first server-side device 72 is established.

Like the first server-side device 72, a fifth response message Mr5 corresponding to the second device search request Rs2 is transmitted from the second server-side device 73 to the second active control device 76. The fifth response message Mr5 contains the second device name information and associated device information corresponding to the second server-side device 73. Consequently, the network connection between the second active control device 76 and the second server-side device 73 is established. Like the first server-side device 72, a sixth response message Mr6 corresponding to the second device search request Rs2 is transmitted from the third server-side device 74 to the second active control device 76. The sixth response message Mr6 contains the third device name information and associated device information corresponding to the third server-side device 74. Consequently, the network connection between the second active control device 76 and the third server-side device 74 is established.

After the second active control device 76 is connected to the first server-side device 72, the second server-side device 73 and the third server-side device 74 through network connection, the first user who supervises the first server-side device 72 may set the fourth access right information Ir4 corresponding to the second active control device 76 through the third-party device 77. The procedures of setting the fourth access right information Ir4 are similar to the procedures of the step C of the first embodiment, and are not redundantly described herein. That is, according to the settings of the first user, the access right of browsing the first folder Fo1 and the second folder Fo2 is open to the second active control device 76. Similarly, the first user who supervises the second server-side device 73 may set the fifth access right information Ir5 corresponding to the second active control device 76 through the third-party device 77. The procedures of setting the fifth access right information Ir5 are similar to the procedures of the step C of the second embodiment, and are not redundantly described herein. That is, according to the settings of the first user, the access right of browsing the first format media files and the second format media files is open to the second active control device 76. Similarly, the first user who supervises the third server-side device 74 may set the sixth access right information Ir6 corresponding to the second active control device 76 through the third-party device 77. The procedures of setting the sixth access right information Ir6 are similar to the procedures of the step C of the third embodiment, and are not redundantly described herein. That is, according to the settings of the first user, the access right of the first printing function and the second printing function is open to the second active control device 76. Meanwhile, the step G* is completed.

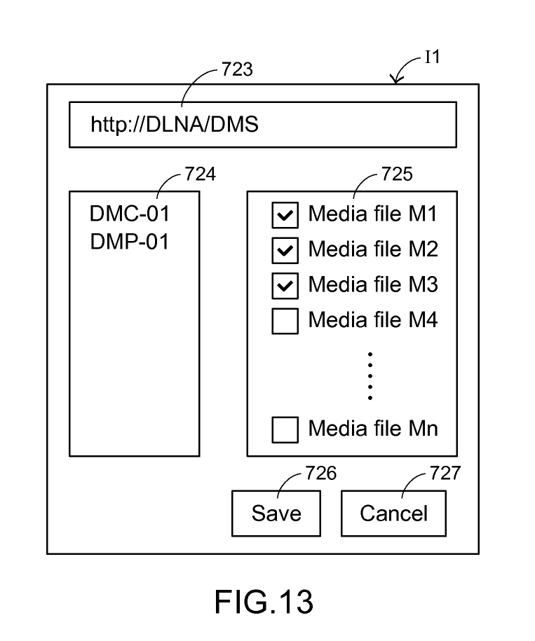

During the process of setting the fourth access right information Ir4 corresponding to the second active control device 76 through the third-party device 77 by the first user, the first access right setting interface I1 provided by the first server-side device 72 is firstly opened by the first user. FIG. 13 schematically illustrates the first access right setting interface of the access right setting system according to the fourth embodiment of the present invention. As shown in FIG. 13, the first access right setting interface I1 comprises a website address bar 723, an active control device list 724, an operation setting field 725, a save button 726, and a cancel button 727. Except that the active control device list 724 contains the control device name corresponding to the first active control device 75 (e.g. DMC-01) and the control device name corresponding to the second active control device 76 (e.g. DMP-01), the contents of the first access right setting interface I1 of this embodiment are substantially identical to the contents of the first access right setting interface I1 of the first embodiment. That reason is that all active control devices connected to the first server-side device 72 through network connection are shown in the active control device list 724. That is, if more active control devices are connected to the first server-side device 72 through network connection, more control device names corresponding to these active control devices are shown in the active control device list 724.

After the access rights of the first active control device 75 and the second active control device 76 to the first server-side device 72, the second server-side device 73 and the third server-side device 74 are set, the second user of the first active control device 75 may operate the first server-side device 72, the second server-side device 73 and the third server-side device 74 through the first active control device 75. For example, when the second user intends to browse the plural media files of the first server-side device 72, a first operating request Rol corresponding to the action of browsing the first server-side device 72 is transmitted to the first server-side device 72 through the first operating interface of the first active control device 75. On the other hand, after the first operating request Rol is received by the first server-side device 72, the first controlling unit 722 of the first server-side device 72 may realize that the first active control device 75 is the device for browsing the first server-side device 72 according to the first access control address information Im1 in the first operating request Rol. Meanwhile, the first controlling unit 722 judges that the first operating request Rol complies with the first access right information In of the first active control device 75 according to the first access right information Ir1. That is, the step D1* is performed. According to the judging result of the first controlling unit 722, a first data packet P1 corresponding to the first folder Fo1 is transmitted from the first controlling unit 722 to the first active control device 75. According to the first data packet P1, the first folder Fo1 is displayed on the first active control device 75. Under this circumstance, the media files M1˜M3 in the first folder Fo1 can be browsed by the second user. That is, the step D2* is performed.

When the second user intends to browse the media file M1 of the first server-side device 72 through the second server-side device 73, a third operating request Ro3 corresponding to the action of controlling the playback of the second server-side device 73 is transmitted from the first active control device 75 to the second server-side device 73 by the second user. According to the first access control address information Im1 in the third operating request Ro3, the second controlling unit of the second server-side device 73 judges that the third operating request Ro3 complies with the second access right information Ir2 of the first active control device 75. That is, the step D1* is performed. According to the judging result of the second controlling unit, the second controlling unit retrieves the media file M1 from the first server-side device 72. After the media file M1 is received by the second controlling unit, the video module is enabled to play the media file M1. That is, the step D2* is performed.

When a third user of the second active control device 76 intends to browse the plural media files of the first server-side device 72, a second operating request Ro2 corresponding to the action of browsing the first server-side device 72 is transmitted to the first server-side device 72 through the second operating interface of the second active control device 76 by the third user. On the other hand, after the second operating request Ro2 is received by the first server-side device 72, the first controlling unit 722 of the first server-side device 72 may realize that the second active control device 76 is the device for browsing the first server-side device 72 according to the second access control address information Im2 in the second operating request Ro2. Meanwhile, the first controlling unit 722 judges that the second operating request Ro2 complies with the fourth access right information Ir4 of the second active control device 76 according to the fourth access right information Ir4. That is, the step H1* is performed. According to the judging result of the first controlling unit 722, the first data packet P1 corresponding to the first folder Fo1 and the second data packet P2 corresponding to the second folder Fo2 are transmitted from the first controlling unit 722 to the second active control device 76. According to the first data packet P1 and the second data packet P2, the first folder Fo1 and the second folder Fo2 are displayed on the second active control device 76. Under this circumstance, the media files M1˜Mn in the first folder Fo1 and the second folder Fo2 can be browsed by the third user. That is, the step H2* is performed.

When the third user intends to print the media file Mn of the first server-side device 72 through the third server-side device 74, a fourth operating request Ro4 corresponding to the action of controlling the printing operation of the third server-side device 74 is transmitted from the second active control device 76 to the third server-side device 74 by the third user. According to the second access control address information Im2 in the fourth operating request Ro4, the third controlling unit of the third server-side device 74 judges that the fourth operating request Ro4 complies with the sixth access right information Ir6 of the second active control device 76. That is, the step H1* is performed. According to the judging result of the third controlling unit, the third controlling unit retrieves the media file Mn from the first server-side device 72. After the media file Mn is received by the third controlling unit, the printing module is enabled to print the media file Mn. That is, the step H2* is performed. Meanwhile, the access right setting method for use in the area network according to the present invention is completed.

In this embodiment, the step D* is performed after the step C*, and the step E* is performed after the step B*. It is not necessary that the step D* is performed after the step E*. In fact, after the step C*, the server-side devices 72˜74 in communication with the first active control device 75 through network connection may be operated through the first active control device 75. Similarly, after the step G*, the server-side devices 72˜74 in communication with the second active control device 76 through network connection may be operated through the second active control device 76.

In other words, the access right setting system 7 may judge whether the operating requests comply with the predetermined access right information according to the operating requests of different active control devices. Consequently, the server-side device is operated in a corresponding access right operation mode according to the access right information.

From the above descriptions, the present invention provides an access right setting system and an access right setting method for use in an area network. During the process of establishing a network connection between the active control device and the server-side device, the media access control address information of the active control device is retrieved, and the identity of the active control device is recognized according to the media access control address information. Subsequently, the access right information corresponding to the active control device is set. When the user intends to operate the server-side device through the active control device, the identity of the active control device is recognized by the server-side device according to the operating request. In addition, the server-side device judges whether the operating request of the active control device complies with the predetermined access right information. Consequently, the server-side device is operated in a corresponding access right operation mode according to the access right information. In other words, the access right setting system can set different access rights of different active control devices, and the server-side device is operated in the corresponding access right operation mode. Under this circumstance, the privacy leakage problem is avoided.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An access right setting method for use in an area network, the access right setting method comprising steps of:
(A) allowing a server-side device of the area network to receive a first device search request from a first active control device of the area network, wherein the first device search request contains a first media access control address information of the first active control device;
(B) retrieving the first media access control address information and storing the first media access control address information into the server-side device, and transmitting a first response message corresponding to the first device search request to the first active control device, so that a network connection between the server-side device and the first active control device is established;
(C) setting a first access right information corresponding to the first active control device into the server-side device according to the first media access control address information and an operation of the third-party device; and
(D) when a first operating request from the first active control device is received by the server-side device, allowing the server-side device to be operated in a first access right operation mode or a second access right operation mode according to the first access right information and the first media access control address information of the first operating request.

2. The access right setting method according to claim 1, wherein the server-side device contains a first folder and a second folder, the first folder contains plural first media files, and the second folder contains plural second media files, wherein according to the first access right information, the first folder is permitted to be displayed, but a restriction information of the second folder is not permitted to be displayed, wherein if the first operating request corresponding to the first folder to be displayed is received by the server-side device in the step (D), a first data packet corresponding to the first folder is transmitted from the server-side device to the first active control device according to the first access right information and the first media access control address information, wherein if the first operating request corresponding to the second folder to be displayed is received by the server-side device in the step (D), a second data packet corresponding to a blank folder is transmitted from the server-side device to the first active control device or a first failed message is transmitted from the server-side device to the first active control device according to the first access right information and the first media access control address information.

3. The access right setting method according to claim 1, wherein the server-side device contains a first media file and a second media file, wherein according to the first access right information, the first media file is permitted to be displayed, but a restriction information of the second media file is not permitted to be displayed, wherein if the first operating request corresponding to the first media file to be displayed is received by the server-side device in the step (D), a first data packet corresponding to the first media file is transmitted from the server-side device to the first active control device according to the first access right information and the first media access control address information, wherein if the first operating request corresponding to the second media file to be displayed is received by the server-side device in the step (D), a second data packet corresponding to no media file is transmitted from the server-side device to the first active control device or a first failed message is transmitted from the server-side device to the first active control device according to the first access right information and the first media access control address information.

4. The access right setting method according to claim 1, wherein the server-side device has a first format playing function and a second format playing function, wherein according to the first access right information, the first format playing function is enabled, but a restriction information of the second format playing function is disabled, wherein if the first operating request corresponding to a first media file to be played is received by the server-side device in the step (D) and the first media file has a first file format, the first media file is retrieved by the server-side device according to the first access right information and the first media access control address information, and the first media file is played by the server-side device, wherein if the first operating request corresponding to a second media file to be played is received by the server-side device in the step (D) and the second media file has a second file format, a first failed message is transmitted from the server-side device to the first active control device according to the first access right information and the first media access control address information.

5. The access right setting method according to claim 1, wherein the server-side device has a first printing function and a second printing function, wherein according to the first access right information, the first printing function is enabled, but a restriction information of the second printing function is disabled, wherein if the first operating request corresponding to a first media file to be printed is received by the server-side device in the step (D) and the first printing function is executed in response to the first operating request, the first media file is retrieved by the server-side device according to the first access right information and the first media access control address information, and the first media file is printed according to the first printing function, wherein if the first operating request corresponding to the first media file to be printed is received by the server-side device in the step (D) and the second printing function is executed in response to the first operating request, a first failed message is transmitted from the server-side device to the first active control device according to the first access right information and the first media access control address information.

6. The access right setting method according to claim 1, wherein the step (C) comprises steps of:
(C1) allowing the third-party device to be connected to the server-side device through network connection, so that a first access right setting interface provided by the server-side device is opened, wherein a first control device name corresponding to the first active control device is shown on the first access right setting interface according to the first media access control address information;
(C2) the server-side device receiving a first access right setting value corresponding to the first active control device from the third-party device; and
(C3) storing the first media access control address information and the first access right setting value into the server-side device as the first access right information.

7. The access right setting method according to claim 1, wherein after the step (B), the access right setting method further comprises steps of:
(E) allowing the server-side device to receive a second device search request from a second active control device of the area network, wherein the second device search request contains a second media access control address information of the second active control device;
(F) retrieving the second media access control address information and storing the second media access control address information into the server-side device, and transmitting a second response message corresponding to the second device search request to the second active control device, so that a network connection between the server-side device and the second active control device is established; and
(G) setting a second access right information corresponding to the second active control device into the server-side device according to the second media access control address information and the operation of the third-party device.

8. An access right setting system, comprising:
a network router providing a network connection function;
a first active control device connected to the network router through network connection, wherein the first active control device has a first media access control address information; and
a server-side device connected to the network router through network connection and connected to the first active control device via the network router through network connection, wherein the server-side device receives the first media access control address information, and a first access right information corresponding to the first active control device is set into the server-side device according to the first media access control address information and an operation of the third-party device, wherein when a first operating request from the first active control device is received by the server-side device, the server-side device is operated in a first access right operation mode or a second access right operation mode according to the first access right information and the first media access control address information of the first operating request.

9. The access right setting system according to claim 8, wherein the server-side device comprises:
a storage element disposed within the server-side device or connected to the server-side device, wherein the first media access control address information and the first access right information are stored in the storage element; and
a controlling unit connected to the storage element, and providing a first access right setting interface, wherein the controlling unit sets the first access right information through the first access right setting interface according to the first media access control address information and the operation of the third-party device, or the controlling unit judges whether the server-side device is operated in the first access right operation mode or the second access right operation mode according to the first access right information and the first media access control address information.

10. The access right setting system according to claim 9, wherein a first folder and a second folder are stored in the storage element, the first folder contains plural first media files, and the second folder contains plural second media files, wherein according to the first access right information, the first folder is permitted to be displayed, but a restriction information of the second folder is not permitted to be displayed, wherein if the first operating request corresponding to the first folder to be displayed is received by the server-side device, a first data packet corresponding to the first folder is transmitted from the controlling unit to the first active control device according to the first access right information and the first media access control address information, wherein if the first operating request corresponding to the second folder to be displayed is received by the server-side device, a second data packet corresponding to a blank folder is transmitted from the controlling unit to the first active control device or a first failed message is transmitted from the controlling unit to the first active control device according to the first access right information and the first media access control address information.

11. The access right setting system according to claim 9, wherein a first media file and a second media file are stored in the storage element, wherein according to the first access right information, the first media file is permitted to be displayed, but a restriction information of the second media file is not permitted to be displayed, wherein if the first operating request corresponding to the first media file to be displayed is received by the server-side device, a first data packet corresponding to the first media file is transmitted from the controlling unit to the first active control device according to the first access right information and the first media access control address information, wherein if the first operating request corresponding to the second media file to be displayed is received by the server-side device, a second data packet corresponding to no media file is transmitted from the server-side device to the first active control device or a first failed message is transmitted from the controlling unit to the first active control device according to the first access right information and the first media access control address information.

12. The access right setting system according to claim 9, wherein the controlling unit has a first format playing function and a second format playing function, wherein according to the first access right information, the first format playing function is enabled, but a restriction information of the second format playing function is disabled, wherein if the first operating request corresponding to a first media file to be played is received by the server-side device and the first media file has a first file format, the first media file is retrieved by the controlling unit according to the first access right information and the first media access control address information, and the first media file is played by the controlling unit, wherein if the first operating request corresponding to a second media file to be played is received by the server-side device and the second media file has a second file format, a first failed message is transmitted from the controlling unit to the first active control device according to the first access right information and the first media access control address information.

13. The access right setting system according to claim 9, wherein the controlling unit has a first printing function and a second printing function, wherein according to the first access right information, the first printing function is enabled, but a restriction information of the second printing function is disabled, wherein if the first operating request corresponding to a first media file to be printed is received by the server-side device and the first printing function is executed in response to the first operating request, the first media file is retrieved by the controlling unit according to the first access right information and the first media access control address information, and the first media file is printed according to the first printing function, wherein if the first operating request corresponding to the first media file to be printed is received by the server-side device and the second printing function is executed in response to the first operating request, a first failed message is transmitted from the controlling unit to the first active control device according to the first access right information and the first media access control address information.

14. The access right setting system according to claim 8, wherein the server-side device is a digital media server, a digital media renderer or a digital media printer according to a DLNA protocol, and the first active control device is a digital media controller or a digital media player according to the DLNA protocol, wherein the network router, the server-side device and the first active control device are collaboratively defined as an area network.

15. The access right setting system according to claim 8, further comprising a second active control device, wherein the second active control device is connected to the network router through network connection and connected to the server-side device via the network router through network connection, wherein the second active control device has a second media access control address information, wherein when a second operating request from the second active control device is received by the server-side device, the server-side device is operated in a third access right operation mode or a fourth access right operation mode according to a second access right information corresponding to the second active control device and the second media access control address information of the second operating request.
